(19) United States
(12) Patent Application Publication
(10) Pub. No.: US 2022/0392092 A1
(43) Pub. Date: Dec. 8, 2022

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Satoru Komatsu, Cambridge, MA (US); Hiroaki Senzaki, Tokyo (JP)

(21) Appl. No.: 17/819,743

(22) Filed: Aug. 15, 2022

Related U.S. Application Data
(63) Continuation of application No. PCT/JP2021/004498, filed on Feb. 8, 2021.

(30) Foreign Application Priority Data
Feb. 26, 2020 (JP) 2020-031080

(51) Int. Cl. G06T 7/55; G06V 10/40; G06V 10/74; G06T 5/40

(52) U.S. Cl. CPC G06T 7/55; G06V 10/40; G06V 10/761; G06T 5/40; G06T 2207/10028; G06T 2207/20021

(57) ABSTRACT

An image processing apparatus includes a unit (input unit) configured to acquire image data and depth information corresponding to the image data, a unit (layer division image generation unit) configured to generate layer division image data based on the depth information by dividing the image data into a plurality of layers depending on a subject distance, and a unit (output unit) configured to output the layer division image data. The layer division image data includes image data of a first layer including image data corresponding to a subject at a subject distance less than a first distance, and image data of a second layer including image data corresponding to a subject at a subject distance larger than or equal to the first distance. The first distance changes based on the depth information.

### CROSS-REFERENCE TO RELATED APPLICATIONS

This application is a Continuation of International Patent Application No. PCT/JP2021/004498, filed Feb. 8, 2021, which claims the benefit of Japanese Patent Application No. 2020-031080, filed Feb. 26, 2020, both of which are hereby incorporated by reference herein in their entirety.

### BACKGROUND

### Technical Field

The aspect of the embodiments relates to an image processing apparatus, an image processing method, and a storage medium.

### Background Art

An apparatus or system is known that forms a molding such as a stereoscopic relief based on a captured image. Patent Literature (PTL) 1 discloses a digital camera that generates a distance map based on a captured image and converts the distance map into depth information to generate stereoscopic image data, and a three-dimensional (3D) printer that generates a relief based on the stereoscopic image data output from the digital camera.

Meanwhile, there is provided a molding having a layer structure formed of a plurality of light-transparent plates with printed images, stacked on top of each other, thus making a stereoscopic expression.

### CITATION LIST

### Patent Literature

PTL 1: Japanese Patent Application Laid-Open No. 2018-42106

In the case of a stereoscopic molding formed by using a 3D printer, depth information in the stereoscopic image data is continuous data. On the other hand, in the case of the molding that expresses a stereoscopic effect by printing an image on each of a plurality of plates, the depth that can be expressed is discrete data. Thus, it is necessary to generate image data (hereinafter referred to as layer division image data) that indicates which portion of each image is to be printed on which plate (layer). However, a technique for forming such layer division image data based on image data has not been fully established yet.

### SUMMARY OF THE INVENTION

The aspect of the embodiments is directed to providing an image processing apparatus capable of generating layer division image data to form a molding that expresses a stereoscopic effect by printing an image on each of a plurality of layers based on image data, and also to providing a method for controlling the image processing apparatus and a program.

According to an aspect of the embodiments, an image processing apparatus includes at least one processor or circuit which functions as an acquisition unit configured to acquire image data and depth information corresponding to the image data, an image processing unit configured to generate layer division image data based on the depth information by dividing the image data into a plurality of layers depending on a subject distance, and an output unit configured to output the layer division image data, wherein the layer division image data includes image data of a first layer including image data corresponding to a subject at a subject distance less than a first distance, and image data of a second layer including image data corresponding to a subject at a subject distance larger than or equal to the first distance, and wherein the first distance changes based on the depth information.

Other aspects of the disclosure will be clarified in the exemplary embodiments to be described below.

Further features of the disclosure will become apparent from the following description of exemplary embodiments with reference to the attached drawings.

### BRIEF DESCRIPTION OF THE DRAWINGS

FIG. 1 is a block diagram illustrating a functional configuration of an image processing apparatus according to a first exemplary embodiment.

FIG. 2 is a flowchart illustrating processing performed in the first exemplary embodiment.

FIG. 3 is a diagram illustrating a captured image to describe layer division image generation processing according to first to fourth exemplary embodiments.

FIG. 4A is a diagram illustrating distance-based layer division according to the first to fourth exemplary embodiments.

FIG. 4B is a diagram illustrating the distance-based layer division according to the first exemplary embodiment.

FIG. 5A illustrates an example of distance division in processing performed in the first exemplary embodiment.

FIG. 5B illustrates an example of the distance division in the processing performed in the first exemplary embodiment.

FIG. 5C illustrates an example of the distance division in the processing performed in the first exemplary embodiment.

FIG. 5D illustrates an example of the distance division in the processing performed in the first exemplary embodiment.

FIG. 6A illustrates a layer division image generated in processing performed in the first exemplary embodiment.

FIG. 6B illustrates a layer division image generated in the processing performed in the first exemplary embodiment.

FIG. 6C illustrates a layer division image generated in the processing performed in the first exemplary embodiment.

FIG. 6D illustrates a layer division image generated in the processing performed in the first exemplary embodiment.

FIG. 7A illustrates an example of distance division in processing performed in the second exemplary embodiment.

FIG. 7B illustrates an example of the distance division in the processing performed in the second exemplary embodiment.

FIG. 7C illustrates an example of the distance division in the processing performed in the second exemplary embodiment.

FIG. 7D illustrates an example of the distance division in the processing performed in the second exemplary embodiment.

FIG. 8A illustrates a layer division image generated in processing performed in the second exemplary embodiment.

FIG. 8B illustrates a layer division image generated in the processing performed in the second exemplary embodiment.

FIG. 8C illustrates a layer division image generated in the processing performed in the second exemplary embodiment.

FIG. 8D illustrates a layer division image generated in the processing performed in the second exemplary embodiment.

FIG. 9A illustrates an example of distance division in processing performed in a modification of the second exemplary embodiment.

FIG. 9B illustrates an example of the distance division in the processing performed in the modification of the second exemplary embodiment.

FIG. 9C illustrates an example of the distance division in the processing performed in the modification of the second exemplary embodiment.

FIG. 9D illustrates an example of the distance division in the processing performed in the modification of the second exemplary embodiment.

FIG. 10 is a block diagram illustrating a functional configuration of an imaging apparatus according to the third exemplary embodiment.

FIG. 11A illustrates an image sensor according to the third exemplary embodiment.

FIG. 11B illustrates the image sensor according to the third exemplary embodiment.

FIG. 12A illustrates a principle of distance measurement by an imaging plane phase-difference method.

FIG. 12B illustrates a principle of the distance measurement by the imaging plane phase-difference method.

FIG. 12C illustrates a principle of the distance measurement by the imaging plane phase-difference method.

FIG. 12D illustrates a principle of the distance measurement by the imaging plane phase-difference method.

FIG. 12E illustrates a principle of the distance measurement by the imaging plane phase-difference method.

FIG. 13A is a flowchart illustrating processing performed in the third exemplary embodiment.

FIG. 13B is a flowchart illustrating processing performed in the third exemplary embodiment.

FIG. 14 is a block diagram illustrating a functional configuration of an image processing apparatus according to the fourth exemplary embodiment.

### DESCRIPTION OF THE EMBODIMENTS

Exemplary embodiments of the disclosure will be described in detail below with reference to the accompanying drawings. The following exemplary embodiments do not limit the disclosure to the ambit of the appended claims. Although a plurality of features is described in the exemplary embodiments, not all of the plurality of features is indispensable to the disclosure, and the plurality of features may be combined in any way. In the accompanying drawings, identical or similar components are assigned the same reference numerals, and thus duplicated descriptions thereof will be omitted.

Exemplary embodiments will be described below centering on an example of a system that generate layer division image data indicating which image is to be printed on which layer based on an image captured by a digital camera. The exemplary embodiments are also applicable to an imaging apparatus capable of acquiring image data. Examples of such imaging apparatus may include a mobile phone, a game machine, a tablet terminal, a personal computer, and a watch type or glasses type imaging apparatus.

A first exemplary embodiment will be described below centering on a system including an image processing apparatus that receives input of image data and depth information corresponding to the image data, generates the layer division image data based on the input data, and outputs the layer division image data to the outside.

### Configuration of Image Processing Apparatus 100

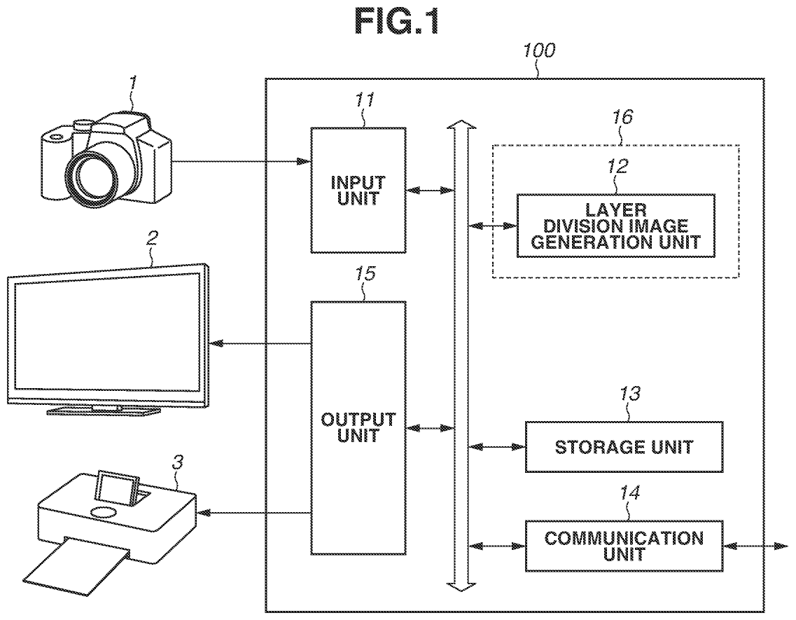

FIG. 1 is a block diagram illustrating an example of a functional configuration of an image processing apparatus 100 according to the present exemplary embodiment. One or more function blocks illustrated in FIG. 1 may be implemented by hardware such as an application specific integrated circuit (ASIC) and a programmable logic array (PLA) or implemented by a programmable processor such as a central processing unit (CPU) and a micro processing unit (MPU) executing software. In addition, the function blocks may be implemented by a combination of software and hardware. Thus, in the following descriptions, even if different function blocks are described as operating entities, the function blocks can be implemented by the same hardware entity.

The image processing apparatus 100 includes an input unit 11 that acquires image information and imaging information about an image captured by an imaging apparatus 1, a layer division image generation unit 12 that generates the layer division image data based on the acquired image information and the imaging information, and a storage unit 13 that stores the generated layer division image data. The image processing apparatus 100 further includes an output unit 15 that outputs the layer division image data to the outside, and a communication unit 14 that communicates with the outside.

The input unit 11 is an interface (I/F) for acquiring the image information and the imaging information captured by the imaging apparatus 1. The image information may be directly acquired from the imaging apparatus 1, or acquired from an external storage device (not illustrated) such as a computer that has acquired the information from the imaging apparatus 1 and stored the information. The imaging information acquired in this case includes the depth information, and may also include imaging conditions and image processing parameters. The depth information may be any information corresponding to the distance to a subject. For example, the depth information may be parallax information or defocus information acquired by pixels for distance measurement included in an image sensor of the imaging apparatus 1, or may be subject distance information. Desirably, the depth information has the same view point and the same angle of field as those of the captured image to be acquired and is a distance image having the same resolution as that of the captured image. If at least one of the view point, angle of field, and resolution is different, it is desirable to convert the distance information to make the view point, angle of field, and resolution the same as those of the captured image. The input unit 11 may acquire device information about the imaging apparatus 1 that has captured the image information.

An image processing unit 16 subjects the image data acquired from the input unit 11, the storage unit 13, or the communication unit 14 to various image processing such as luminance and color conversion processing, processing for correcting a defective pixel, shading, and noise components, filter processing, and image combining processing. The image processing unit 16 according to the present exemplary embodiment includes the layer division image generation unit 12. The layer division image generation unit 12 generates the layer division image data that indicates which layer is to be formed of which image based on the image information and the depth information acquired from the input unit 11, the storage unit 13, or the communication unit 14. Processing for generating the layer division image data will be described in details below. Although FIG. 1 illustrates only the layer division image generation unit 12, the image processing unit 16 may have other functional blocks. For example, the image processing unit 16 may subject the image data to contrast and white balance adjustment processing and color correction processing.

The storage unit 13 includes such a recording medium as a memory for storing image data, parameters, imaging information, device information about the imaging apparatus, and other various information input via the input unit 11 or the communication unit 14. The storage unit 13 also stores the layer division image data generated by the layer division image generation unit 12.

The communication unit 14 is a communication interface (I/F) that transmits and receives data to/from an external apparatus. In the present exemplary embodiment, the communication unit 14 communicates with the imaging apparatus 1, a display unit 2, or a printing apparatus 3, and acquires device information about the imaging apparatus 1, the display unit 2, or the printing apparatus 3.

The output unit 15 is an interface that outputs the generated layer division image data to the display unit 2 or the printing apparatus 3 that is an output destination.

The printing apparatus 3 prints image data divided for each layer on plates having high light-transparency, such as acrylic sheets, based on the layer division image data input from the image processing apparatus 100. When the input layer division image data indicates that the image data is to be divided into three different layers and then printed, the printing apparatus 3 prints respective images on first to third layers on three different acrylic sheets. A molding can be manufactured by stacking the plate with the first layer image printed thereon, the plate with the second layer image printed thereon, and the plate with the third layer image printed thereon, on top of each other, to form a single object. Alternatively, a molding may be manufactured by fixing the layers to have a gap between the layers.

### Processing for Generating Layer Division Image Data

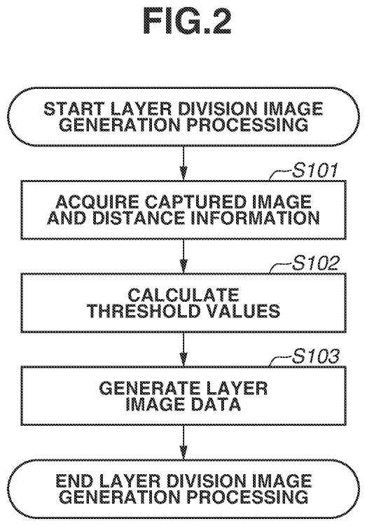

Processing for generating the layer division image data performed by the image processing apparatus 100 will be specifically described below with reference to the flowchart in FIG. 2. The processing will be described below centering on an example where the distance information indicating the distance to the subject is used as the depth information. In a case where the parallax information is used, the image processing apparatus 100 performs similar processing to generate the layer division image data. When the layer division image generation unit 12 is configured to include a programmable processor, each step of the processing is implemented by the layer division image generation unit 12 reading a processing program stored in the storage unit 13, loading the program into a volatile memory (not illustrated), and executing the program.

In step S101, the input unit 11 acquires a captured image captured by the imaging apparatus 1 and the distance information corresponding to the captured image from the imaging apparatus 1 or an external storage device.

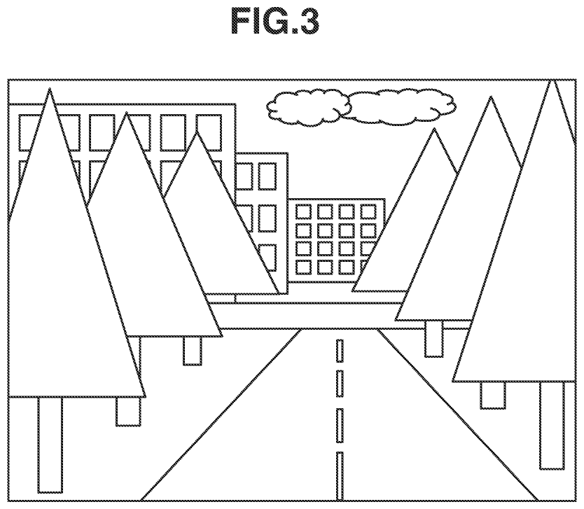

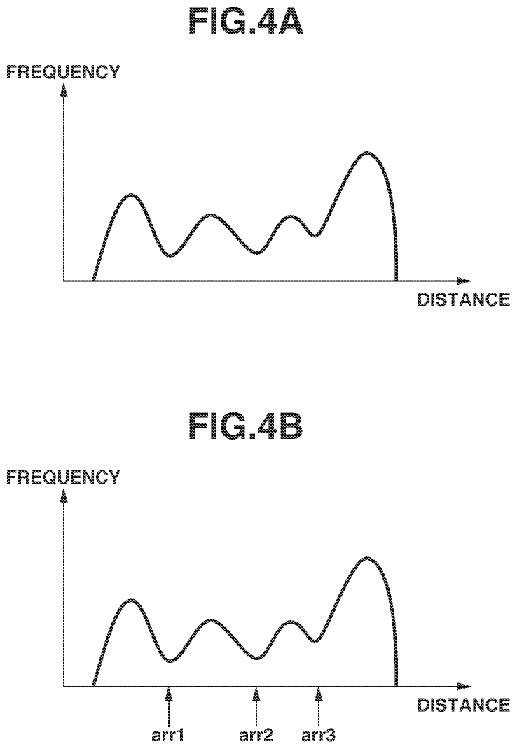

In step S102, the layer division image generation unit 12 calculates threshold values at which the image data is divided into a plurality of regions based on subject distances by using the distance information acquired in step S101 and the preset number of division layers. The threshold values are calculated by performing distance-based clustering through the k-means clustering. For example, when the captured image illustrated in FIG. 3 is used as original image data, a histogram of the distance information corresponding thereto has a shape as illustrated in FIG. 4A. A case is considered where four different division layers (classes) are subjected to clustering with respect to the distance illustrated in FIG. 4A. Referring to the distance represented on the horizontal axis in FIG. 4A, a side closer to the origin (left-hand side) is closer to the imaging apparatus 1 that has captured the image. In the case of such distance distribution, the distance is divided into four different ranges of the subject distance based on the k-means clustering. More specifically, thresholds arr1, arr2, and arr3 indicated by arrows in FIG. 4B represent boundaries between the ranges. The range from the imaging apparatus 1 to the threshold arr1 (exclusive) corresponds to the first layer. The range from the threshold arr1 (inclusive) to the threshold arr2 (exclusive) corresponds to the second layer. The range from the threshold arr2 (inclusive) to the threshold arr3 (exclusive) corresponds to the third layer. The range starting from the threshold arr3 (inclusive) corresponds to the fourth layer.

The distance clustering method is not limited to the k-means clustering. Other clustering methods such as the discriminant analysis method and the hierarchical clustering method are also applicable. The number of division layers may be predetermined regardless of the image data or preset by the user. The number of division layers can also be automatically determined by the layer division image generation unit 12 based on the distance information. The excessive number of layers may cause degradation of the light transmissivity when the layers that have been printed are stacked on top of each other and then the image is displayed. Therefore, the suitable number of layers is assumed to be 2 to 10. When the layer division image generation unit 12 acquires the threshold values (arr1, arr2, and arr3) to be used for layer division, the processing proceeds to step S103.

In step S103, the layer division image generation unit 12 divides the image data by using the calculated threshold values of the distance and generates the layer division image data, which is data on images for respective layers obtained by dividing the image data. The image data of the first layer is generated by selecting the pixel value corresponding to the pixel position at a distance included in the first layer from the image data, setting the target pixel value to the selected pixel value, and setting other pixel values to the maximal pixel value to enable light transmission at the time of printing. In other words, the image data of the first layer is generated by extracting, from the image data, the image information about the subjects at subject distances less than the threshold arr1, and setting the maximal pixel value to pixels with no pixel value.

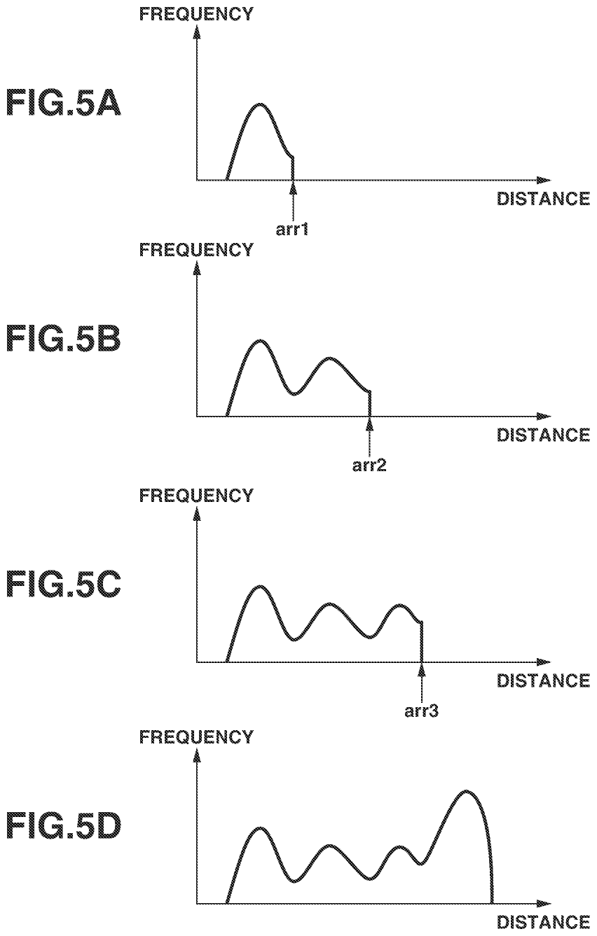

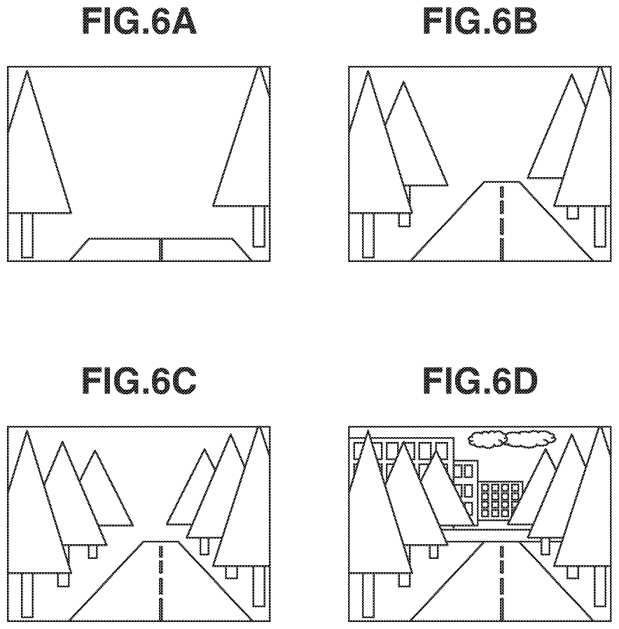

FIG. 5A illustrates a histogram of the selected distance, and FIG. 6A illustrates a generated image of the first layer. As illustrated in FIG. 6A, in the image data of the first layer, the pixel value of the image data is set to positions of subjects at subject distances less than the threshold arr1 (less than the first distance) from the imaging apparatus 1, and the maximum value is set to other regions. In other words, the image data of the first layer includes image data corresponding to the subjects at the subject distances less than the threshold arr1.

The image data of the second and subsequent layers is generated to include image data of subjects at distances corresponding to the target layer, and the image data of the subjects at distances corresponding to all layers that are at distances shorter than the distance of the target layer. More specifically, as illustrated in FIG. 5B, the image data of the second layer is generated by using the pixel values at the pixel positions corresponding to the subjects at the subject distances less than the threshold arr2 (less than the second distance), i.e., within a distance range including the first and second layers. Thus, as illustrated in FIG. 6B, the image data of the second layer includes the image data corresponding to the subjects at the subject distances less than the threshold arr2. In the image data, the maximum value is set to the pixel values of subject regions at the subject distances larger than or equal to the threshold arr2 (the second distance or larger).

Likewise, as illustrated in FIG. 5C, the image data of the third layer is generated by using the pixel values at the pixel positions corresponding to the subjects at the subject distances less than the threshold arr3 (less than the third distance), i.e., the distance range including the first to the third layers. Thus, as illustrated in FIG. 6C, the image data of the third layer includes image data corresponding to subjects at subject distances less than the threshold arr3 (less than the third distance). In the image data, the maximum value is set to the pixel values of subject regions at the subject distances larger than or equal to the threshold arr3 (the third distance or larger).

In this example, as illustrated in FIG. 5D, the image data of the fourth layer, which is image data of the farthest layer, is generated by using the pixel values at the pixel positions corresponding to the subjects at all of the subject distances. More specifically, as illustrated in FIG. 6D, the image data of the farthest layer includes the image data corresponding to all of the subjects, and hence an image similar to the captured image illustrated in FIG. 3 is obtained.

As described above, the processing for generating the layer division image data generates a plurality of pieces of image data divided by the specified number of division layers by using the distance information. The generated layer division image data is stored in the storage unit 13 and, at the same time, is output to the external printing apparatus 3 that prints the image data.

The image processing unit 16 may perform luminance correction and color correction on each of the division images. For example, a depth effect and a stereoscopic effect may be expressed by gradually increasing or decreasing the luminance value of the image data of the first layer. Since the subjects included in the image data of the first layer are included in the image data of the first to fourth layers, colors resulting from superimposition of all of the layers are observed from the front side. Thus, the color correction and the luminance correction may be performed only on portions subjected to printing across a plurality of layers.

In the first exemplary embodiment, in a layer at a larger distance from the imaging apparatus, the larger number of layer division images is superimposed. In the layer farthest from the imaging apparatus, the same image as the captured image is obtained. When division images are printed and then the layers are superimposed in this way, the observed image provides a lowered background light transmissivity in a region where the same image is printed across a plurality of layers, possibly resulting in degraded visibility. For example, in the case of the captured image illustrated in FIG. 3, the background light transmissivity in the region of the near-side tree is lower (and the image is darker) than that in the region of the far-side tree, and thus the former region is assumed to be darker than the latter region.

In a second exemplary embodiment, processing for generating the layer division image data that can reduce the visibility degradation due to the image superimposition will be described below. The configuration of the image processing apparatus 100 is similar to that according to the first exemplary embodiment, and thus redundant descriptions thereof will be omitted. The flowchart of the processing for generating the layer division image data is similar to the flowchart in FIG. 2, but only the method for generating a layer image in step S103 is different. Thus, the processing in step S103 according to the present exemplary embodiment will be described below.

In the present exemplary embodiment, the image data in the second and subsequent layers does not include information about layers at shorter distances than the target layer. Each piece of the layer division image data is generated by using only pixel values of pixels at positions corresponding to subject regions included in the distance range of the target layer.

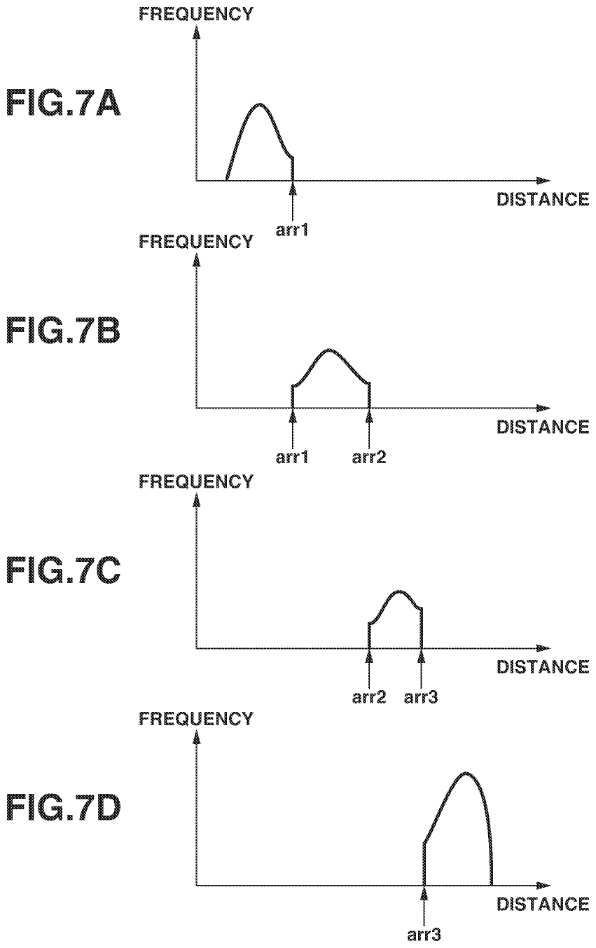

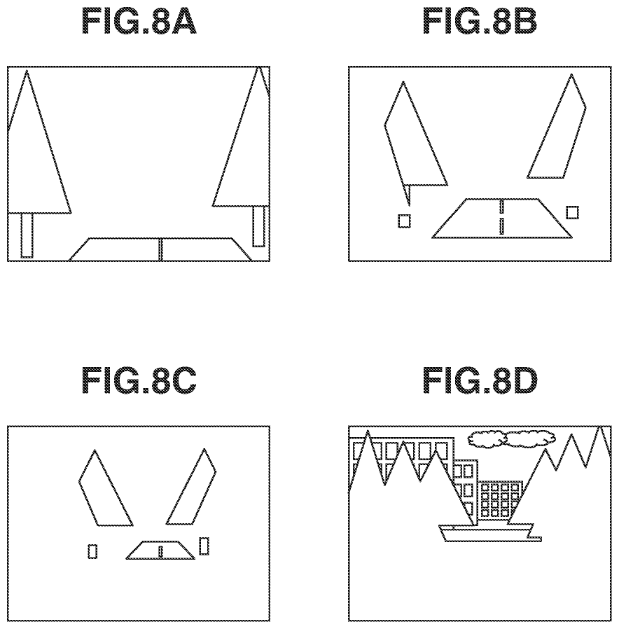

FIGS. 7A to 7D illustrate distance-based histograms of the image data of the captured image in FIG. 3 where the image data is divided into each layer by using the processing method according to the present exemplary embodiment. FIGS. 8A to 8D illustrate images indicated by pieces of the image data. FIGS. 7A to 7D illustrate histograms of the image data of the first to fourth layers, respectively. FIGS. 8A to 8D illustrate the image data of the first to fourth layers, respectively. As illustrated in FIG. 7A, the image data of the first layer includes image data corresponding to the subjects at subject distances less than the threshold arr1. As illustrated in FIG. 8A, the image data corresponding to portions of two trees and a road located on the near side when viewed from the imaging apparatus is included. As illustrated in FIG. 7B, the image data of the second layer includes image data corresponding to subjects at subject distances of the threshold arr1 (inclusive) to the threshold arr2 (exclusive). As illustrated in FIG. 8B, the image data corresponding to subjects located slightly farther (i.e., at larger subject distances) than the subjects in the image data of the first layer is included. As illustrated in FIG. 7C, the image data of the third layer includes image data corresponding to subjects at subject distances of the threshold arr2 (inclusive) to the threshold arr3 (exclusive). As illustrated in FIG. 8C, the image data corresponding to the subjects located slightly farther than the subjects in the image data of the second layer is included. As illustrated in FIG. 7D, the image data of the fourth layer includes image data corresponding to subjects at subject distances larger than or equal to the threshold arr3. As illustrated in FIG. 8D, the image data corresponds to subjects located farther than the subjects in the image data of the third layer. In the image data of the second to fourth layers, the pixel values of the pixels corresponding to the subjects included in the image data of the first layer are set to the maximum value. In the image data of the first, third, and fourth layers, the pixel values of the pixels corresponding to the subjects included in the image data of the second layer are set to the maximum value. Likewise, the pixel values of the pixels corresponding to the subjects included in the image data of the third and fourth layers are set to the maximum value in the image data of other layers.

As described above, in the processing for generating the layer division image data according to the present exemplary embodiment, the pixel value at the same pixel position is not selected in a plurality of layers. Thus, printed regions are not superimposed even if the layers on which respective image data are printed are stacked on top of each other. Thus, the background light transmissivity is improved, and the possibility of visibility degradation is reduced in comparison with a case where the image data corresponding to each layer includes the image data corresponding to all of the subjects at the subject distances less than or equal to the threshold value, as in the first exemplary embodiment.

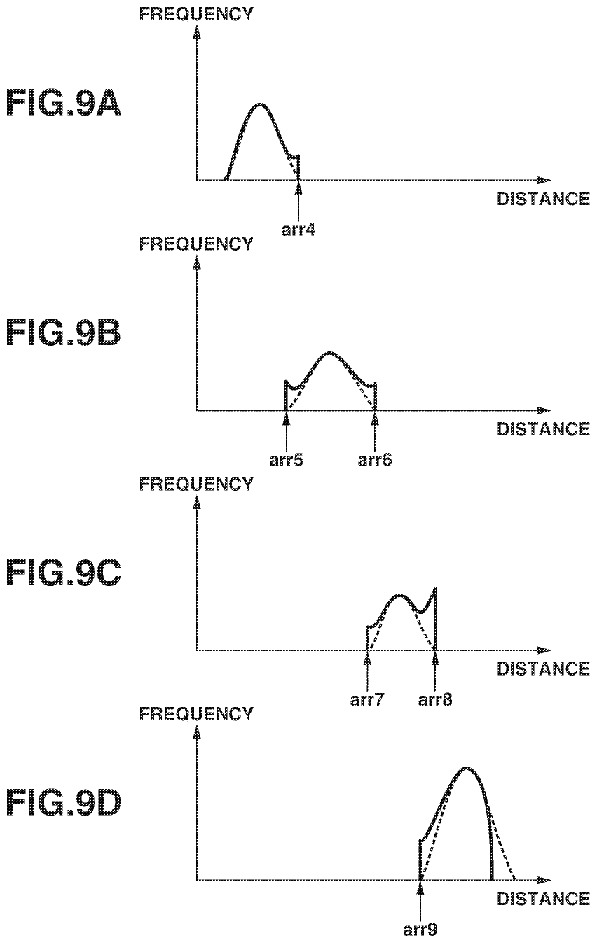

When layer division images are printed by the method according to the second exemplary embodiment and then superimposed with gaps provided between the layers, regions with no image are formed in boundary regions between the layers because of the gaps provided between the layers, when the images are observed from an oblique direction. To prevent such regions from being formed, boundaries of distance between the layers may be overlapped, as illustrated in FIGS. 9A to 9D. When the image data of the first layer includes the image data of the subjects at subject distances less than a threshold arr4, as illustrated in FIG. 9A, the image data of the second layer is generated to include the image data of the subjects at subject distances larger than or equal to a threshold arr5, which is less than the threshold arr4, as illustrated in FIG. 9B. Likewise, when the image data of the second layer includes the image data of the subjects at subject distances less than a threshold arr6, the image data of the third layer is generated to include the image data of the subjects at subject distances larger than or equal to a threshold arr7, which is less than the threshold arr6, as illustrated in FIG. 9C. Likewise, when the image data of the third layer includes the image data of the subjects at subject distances less than a threshold arr8, the image data of the fourth layer is generated to include the image data of the subjects at subject distances larger than or equal to a threshold arr9 which is less than the threshold arr8, as illustrated in FIG. 9D. In FIGS. 9A to 9D, there are relations arr5<arr1<arr4, arr7<arr2 <arr6, and arr9<arr3 <arr8. However, the overlapping method is not limited thereto as long as the boundaries of distance are overlapped.

Since the boundaries of distance are overlapped between the layers in this way, the image corresponding to the subject region in the vicinity of the boundaries of distance between the layers is included in the image data of both of the layers. When the gaps between the layers are the same when the image is observed from an oblique direction, the regions with no image can be reduced in size. This is particularly effective in a region where layer division is made in the middle of the continuous distance. The amount of the overlapped distance may be predetermined or determined by the layer division image generation unit 12 based on the distance information corresponding to the input image data. For example, referring to a histogram of the distance, an average μ1 and a standard deviation σ1 of the distances in the range between the thresholds arr1 and arr2 are obtained, and the amount of the overlapped distance is determined based on arr5=μ1−ασ1 and arr6=μ1+ασ1 by using a coefficient a for the standard deviation σ1. The coefficient a is determined so that relations arr5<arr1 and arr2<arr6 are satisfied. In FIG. 9B, in the first exemplary embodiment, the lower limit of the distance is the threshold arr1. If a subject the subject distance of which is continuously changing exists in the vicinity of threshold arr1, the subject is divided into the layers. Thus, the subject being divided into the layers can be avoided by setting the threshold arr5, which is less than the threshold arr1, as the lower limit distance so that a bottom portion of a peak drawn with a dotted line is included in the range, as in the present modification.

In FIGS. 9A to 9D, the range of the subject distance is set so that the bottom portion of the peak is included in the target layer at all of the boundaries of the first to fourth layers. However, the overlapping method is not limited thereto. An example case of two adjacent layers will be described below. Threshold values set by clustering as illustrated in FIGS. 7A to 7D may be used for one of the two layers including images at shorter subject distances. For the other of the two layers including images at longer subject distances, lower limit distances may be set so that the bottom portion of the peak is included in the range as illustrated in FIGS. 9A to 9D. When the layer division image data is generated in this way, the image data of the first layer includes the image data of the subjects at subject distances less than the threshold arr1, and the image data of the second layer includes the image data of the subjects at subject distances of the threshold arr5 (inclusive) to the threshold arr2 (exclusive). By setting the range of only one of the layers including the images at longer subject distances so that the bottom portion of the peak is included in the range in this way, an expression with emphasized edges of the subjects at shorter subject distances (on the nearer side when viewed from the imaging apparatus 1) can be made.

In addition, the images in the layer including the focus position may be generated based on threshold values as illustrated in FIGS. 7A to 7D, and the images in other layers may be generated based on the distance ranges set to include the bottom portion of the peak as illustrated in FIGS. 9A to 9D. Generating the image data for each layer in this way enables making an expression with emphasized edges of the subject in the vicinity of the focus. For example, in a case where the in-focus position exists in the distance range of the second layer (for example, in the distance range of the threshold arr1 (inclusive) to the threshold arr2 (exclusive)), the image data of the first, third, and fourth layers may be generated as illustrated in FIGS. 9A to 9D, and the image data of the second layer may be generated as illustrated in FIGS. 7A to 7D.

As another technique, by sequentially and gradually enlarging the image of each layer generated in the second exemplary embodiment to generate superimposed regions, the regions with no image can be reduced in size when the images are observed from an oblique direction.

It is also possible to determine whether to perform the above-described processing method according to the second exemplary embodiment or the processing method for reducing gaps between the images according to the modification, based on the distance information corresponding to the input image information.

The first exemplary embodiment has been described above centering on a form in which an image processing apparatus connected with the imaging apparatus 1 generates the layer division image data. A third exemplary embodiment will be described below centering on a form in which an imaging apparatus (digital camera) for acquiring a captured image generates the layer division image data.

### Configuration of Imaging Apparatus 300

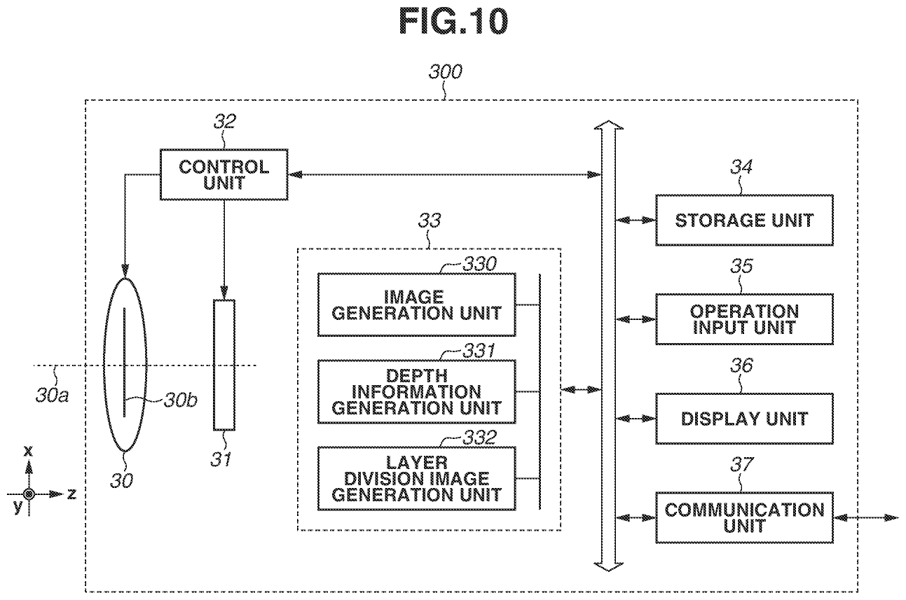

A configuration of an imaging apparatus 300 will be described below with reference to FIG. 10. FIG. 10 is a block diagram illustrating a functional configuration of the imaging apparatus 300 incorporating conversion information calculation processing.

An imaging optical system 30 includes a lens unit included in the imaging apparatus 300 or a lens apparatus attachable to a camera body, and forms an optical image of a subject on an image sensor 31. The imaging optical system 30 includes a plurality of lenses arranged in a direction of an optical axis 30a, and an exit pupil 30b disposed at a position a predetermined distance away from the image sensor 31. Herein, a z direction (depth direction) is defined as a direction parallel to the optical axis 30a. More specifically, the depth direction is the direction in which a subject exists in the real space relative to the position of the imaging apparatus 300. A direction perpendicular to the optical axis 30a and parallel to a horizontal direction of the image sensor 31 is defined as an x direction. The direction perpendicular to the optical axis 30a and parallel to a vertical direction of the image sensor 31 is defined as a y direction.

The image sensor 31 is, for example, a charge coupled device (CCD) image sensor or a complementary metal oxide semiconductor (CMOS) image sensor. The image sensor 31 performs photoelectric conversion on a subject image formed on an imaging plane via the imaging optical system 30, and outputs an image signal related to the subject image. The image sensor 31 according to the present exemplary embodiment has a function of outputting a signal that enables distance measurement by an imaging plane phase difference method as described above. The image sensor 31 outputs not only a captured image but also a parallax signal for generating distance information indicating a distance (subject distance) from the imaging apparatus to the subject.

A control unit 32 including a central processing unit (CPU) and a micro processing unit controls operations of the components included in the imaging apparatus 300. For example, during image capturing, the control unit 32 performs automatic focus adjustment (AF), changes the focusing position, changes the F value (aperture value), and captures an image. The control unit 32 also controls an image processing unit 33, a storage unit 34, an operation input unit 35, a display unit 36, and a communication unit 37.

The image processing unit 33 performs various image processing provided by the imaging apparatus 300. The image processing unit 33 includes an image generation unit 330, a depth information generation unit 331, and a layer division image generation unit 332. The image processing unit 33 includes a memory used as a work area in the image processing. One or more function blocks in the image processing unit 33 may be implemented by hardware such as an application specific integrated circuit (ASIC) or a programmable logic array (PLA), or may be implemented by a programmable processor such as a central processing unit (CPU) or a micro processing unit (MPU) executing software. In addition, the function blocks may be implemented by a combination of software and hardware.

The image generation unit 330 subjects the image signal output from the image sensor 31 to various signal processing including noise removal, demosaicing, luminance signal conversion, aberration correction, white balance adjustment, and color correction. The image data (captured image) output from the image generation unit 330 is accumulated in a memory or the storage unit 34 and is used to display an image on the display unit 36 by the control unit 32 or output an image to an external apparatus via the communication unit 37.

The depth information generation unit 331 generates a depth image (depth distribution information) representing distribution of the depth information based on a signal obtained by pixels for distance measurement included in the image sensor 31 (described below). The depth image is two-dimensional information in which the value stored in each pixel is the subject distance of a subject existing in a region of the captured image corresponding to the pixel. As in the first and second exemplary embodiments, a defocus amount and parallax information may be used instead of the subject distance.

The layer division image generation unit 332 is an image processing unit equivalent to the layer division image generation unit 12 according to the first exemplary embodiment. The layer division image generation unit 332 generates the layer division image data based on the image information and the depth information acquired through image capturing via the imaging optical system 30 and the image sensor 31.

The storage unit 34 is a nonvolatile recording medium that stores captured image data, layer division image data generated by the layer division image generation unit 332, intermediate data generated in an operation process of each block, and parameters referred to in the operations of the image processing unit 33 and the imaging apparatus 300. The storage unit 34 may be a mass-storage recording medium of any type capable of reading and writing data at a high speed as long as permitted processing performance is guaranteed in implementing the processing. A flash memory is a desirable example of the storage unit 34.

The operation input unit 35 is a user interface including, for example, a dial, a button, a switch, and a touch panel. The operation input unit 35 detects input of information and input of a setting change operation to the imaging apparatus 300. Upon detection of an input operation, the operation input unit 35 outputs a corresponding control signal to the control unit 32.

The display unit 36 is a display apparatus such as a liquid crystal display or an organic electroluminescence (EL) display. The display unit 36 is used to confirm the composition of an image to be captured by a live view display and notify the user of various setting screens and message information. If the touch panel as the operation input unit 35 is integrated with a display surface of the display unit 36, the display unit 36 can provide both the display and input functions.

The communication unit 37 is a communication interface included in the imaging apparatus 300, and implements information transmission and reception with an external apparatus. The communication unit 37 may be configured to transmit captured images, the depth information, and the layer division image data to other apparatuses.

### Configuration of Image Sensor

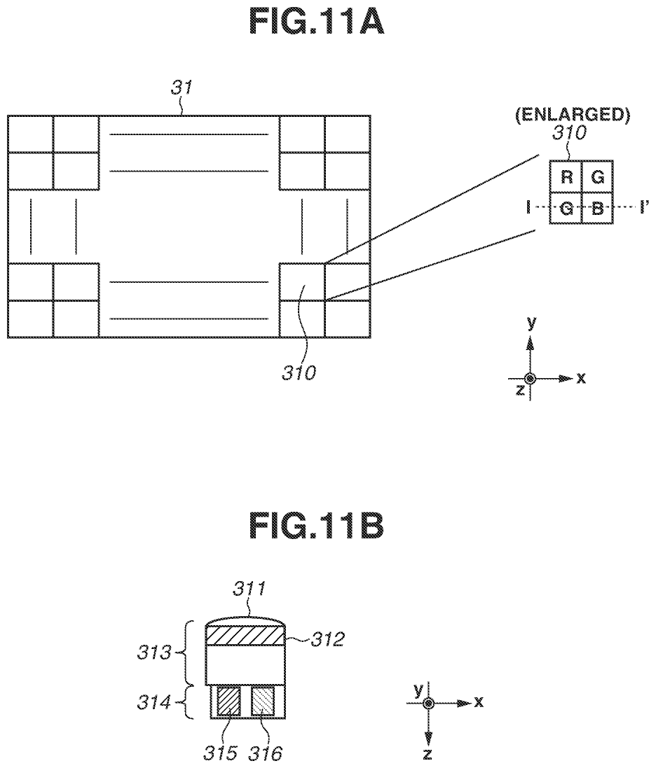

An example of a configuration of the above-described image sensor 31 will be described with reference to FIGS. 11A and 11B. As illustrated in FIG. 11A, the image sensor 31 includes a pixel array formed of a plurality of 2-row by 2-column pixel groups 310 with different color filters. As illustrated in the enlarged portion, each of the pixel groups 310 includes red (R), green (G), and blue (B) color filters. Each pixel (photoelectric conversion element) outputs an image signal indicating R, G, or B color information. In the present exemplary embodiment, an example is described below on the premise that the color filters are distributed as illustrated in FIG. 11A, but the embodiment of the disclosure is not limited thereto.

To implement the distance measurement function by the imaging plane phase-difference method, each pixel (photoelectric conversion element) of the image sensor 31 according to the present exemplary embodiment is formed of a plurality of photoelectric conversion portions in a cross section taken along the I-I′ line in FIG. 11A in the horizontal direction of the image sensor 31. More specifically, as illustrated in FIG. 11B, each pixel is formed of a light guiding layer 313 and a light receiving layer 314. The light guiding layer 313 includes a microlens 311 and a color filter 312, and the light receiving layer 314 includes a first photoelectric conversion portion 315 and a second photoelectric conversion portion 316.

In the light guiding layer 313, the microlens 311 is configured to efficiently guide a light flux incident on the pixel to the first photoelectric conversion portion 315 and the second photoelectric conversion portion 316. The color filter 312 allows passage of light with a predetermined wavelength band, i.e., only light in one of the above-described R, G and B wavelength bands, and guides the light to the first photoelectric conversion portion 315 and the second photoelectric conversion portion 316 in the subsequent stage.

The light receiving layer 314 includes two different photoelectric conversion portions (the first photoelectric conversion portion 315 and the second photoelectric conversion portion 316) that convert received light into analog image signals. Two different signals output from the two photoelectric conversion portions are used for the distance measurement. More specifically, each pixel of the image sensor 31 includes two different photoelectric conversion portions similarly arranged in the horizontal direction. An image signal including signals output from first photoelectric conversion portions 315 of all the pixels, and an image signal including signals output from second photoelectric conversion portions 316 of all the pixels are used. More specifically, each of the first photoelectric conversion portion 315 and the second photoelectric conversion portion 316 partially receives a light flux incident on the pixel through the microlens 311. Thus, the eventually obtained two different image signals form a group of pupil-divided images related to the light flux passing through different regions of the exit pupil 30b of the imaging optical system 30. A combination of the image signals obtained through the photoelectric conversion by the first photoelectric conversion portion 315 and the second photoelectric conversion portion 316 in each pixel is equivalent to an image signal (for viewing) output from one photoelectric conversion portion in a form where only one photoelectric conversion portion is provided in a pixel.

The image sensor 31 having the above-described structure according to the present exemplary embodiment can output an image signal for viewing and an image signal for distance measurement (two different pupil-divided images). The present exemplary embodiment will be described below on the premise that all the pixels of the image sensor 31 include two different photoelectric conversion portions and are configured to output high-density depth information. However, the embodiment of the disclosure is not limited thereto. A pixel for distance measurement including only the first photoelectric conversion portion 315 and a pixel for distance measurement including only the second photoelectric conversion portion 316 may be provided in part of the image sensor 31, and the distance measurement by the imaging plane phase-difference method may be performed by using signals from these pixels.

### Principle of Distance Measurement by Imaging Plane Phase-difference Distance Measurement Method

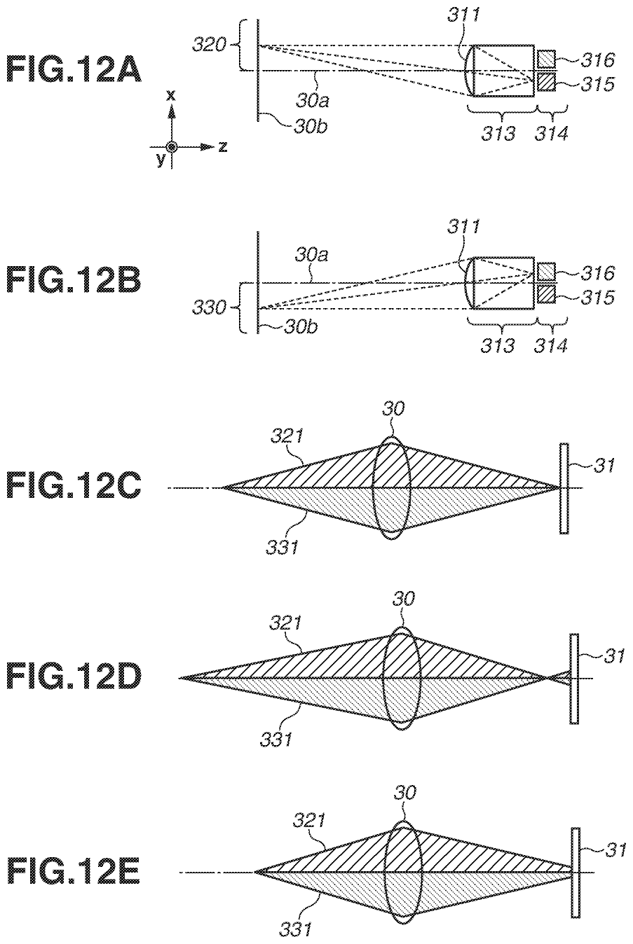

The principle of subject distance calculation based on the group of pupil-divided images output from the first photoelectric conversion portion 315 and the second photoelectric conversion portion 316, performed by the imaging apparatus 300 according to the present exemplary embodiment, will be described with reference to FIGS. 12A to 12E.

FIG. 12A is a schematic view illustrating the exit pupil 30b of the imaging optical system 30 and a light flux received by the first photoelectric conversion portion 315 of a pixel in the image sensor 31. Similarly, FIG. 12B is a schematic view illustrating a light flux received by the second photoelectric conversion portion 316.

The microlens 311 illustrated in FIGS. 12A and 12B is disposed so that the exit pupil 30b and the light receiving layer 314 are in an optically conjugate relation. The light flux passing through the exit pupil 30b of the imaging optical system 30 is condensed and guided to the first photoelectric conversion portion 315 or the second photoelectric conversion portion 316 by the microlens 311. In this case, the first photoelectric conversion portion 315 and the second photoelectric conversion portion 316 mainly receive the light fluxes passing through different pupil regions, as illustrated in FIGS. 12A and 12B, respectively. The first photoelectric conversion portion 315 receives the light flux passing through a first pupil region 320, and the second photoelectric conversion portion 316 receives the light flux passing through a second pupil region 330.

The plurality of first photoelectric conversion portions 315 included in the image sensor 31 mainly receives the light flux passing through the first pupil region 320, and outputs a first image signal. At the same time, the plurality of second photoelectric conversion portions 316 included in the image sensor 31 mainly receives the light flux passing through the second pupil region 330, and outputs a second image signal. The intensity distribution of an image formed on the image sensor 31 by the light flux passing through the first pupil region 320 can be obtained from the first image signal. The intensity distribution of an image formed on the image sensor 31 by the light flux passing through the second pupil region 330 can be obtained from the second image signal.

An amount of relative positional deviation between the first and second image signals (what is called a parallax amount) corresponds to a defocus amount. A relation between the parallax amount and the defocus amount will be described with reference to FIGS. 12C, 12D, and 12E. FIGS. 12C, 12D, and 12E are schematic views illustrating the image sensor 31 and the imaging optical system 30 according to the present exemplary embodiment. In FIGS. 12C, 12D, and 12E, a first light flux 321 passes through the first pupil region 320, and a second light flux 331 passes through the second pupil region 330.

FIG. 12C illustrates an in-focus state where the first light flux 321 and the second light flux 331 converge on the image sensor 31. In this state, the parallax amount between the first image signal formed by the first light flux 321 and the second image signal formed by the second light flux 331 is 0. FIG. 12D illustrates a state of defocusing in a negative direction of a z axis on the image side. In this state, the parallax amount between the first image signal formed by the first light flux 321 and the second image signal formed by the second light flux 331 is not 0 but is a negative value. FIG. 12E illustrates a state of defocusing in a positive direction of the z axis on the image side. In this state, the parallax amount between the first image signal formed by the first light flux 321 and the second image signal formed by the second light flux 331 is a positive value. A comparison between FIGS. 12D and 12E indicates that the direction of the positional deviation is changed depending on the positive or negative defocus amount and that the positional deviation occurs based on an image forming relation (geometric relation) of the imaging optical system depending on the defocus amount. The parallax amount, which is a positional deviation between the first and second image signals, can be detected by a region-based matching technique (described below).

### Image Generation and Depth Image Generation Processing

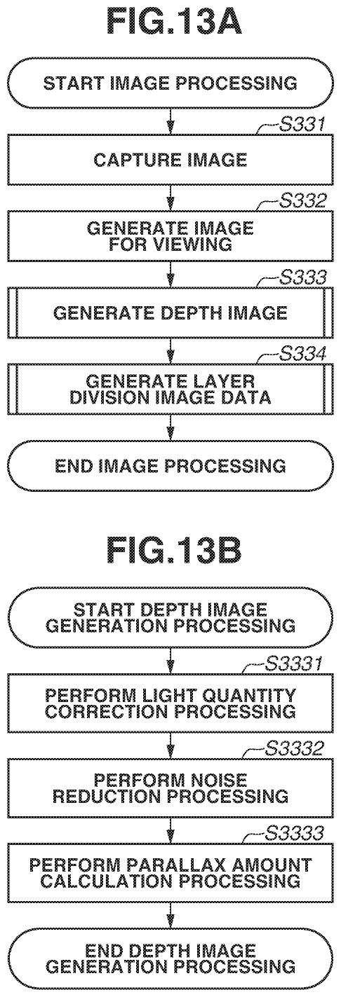

The image generation processing and the depth image generation processing of a captured image of a subject performed by the imaging apparatus 300 having the above-described configuration according to the present exemplary embodiment will be specifically described below with reference to the flowchart in FIG. 13A.

In step S331, the control unit 32 performs processing for capturing an image based on imaging settings such as the focal position, diaphragm, and exposure time. More specifically, the control unit 32 controls the image sensor 31 to capture an image, transmit the image to the image processing unit 33, and store the image in a memory. Herein, captured images include two different image signals S1 and S2. The image signal S1 is formed of a signal output only from the first photoelectric conversion portion 315 included in the image sensor 31. The image signal S2 is formed of a signal output only from the second photoelectric conversion portion 316 included in the image sensor 31.

In step S332, the image processing unit 33 forms an image for viewing from the captured image. More specifically, the image generation unit 330 in the image processing unit 33 adds pixel values of each pixel of the image signals S1 and S2 to generate one Bayer array image. The image generation unit 330 subjects the Bayer array image to demosaicing processing for R, G, and B color images, to form the image for viewing. The demosaicing processing is performed based on the color filters disposed on the image sensor 31. Any types of demosaicing method are applicable. In addition, the image generation unit 330 subjects the image to noise removal, luminance signal conversion, aberration correction, white balance adjustment, and color correction to generate a final image for viewing, and stores the image in a memory.

In step S333, the image processing unit 33 generates a depth image based on the obtained captured image. Processing for generating the depth image is performed by the depth information generation unit 331. The depth image generation processing will be described with reference to the flowchart in FIG. 13B.

In step S3331, the depth information generation unit 331 subjects the image signals S1 and S2 to light quantity correction processing. At a marginal angle of field of the imaging optical system 30, the light quantity balance between the image signals S1 and S2 is collapsed by vignetting due to a difference in shape between the first pupil region 320 and the second pupil region 330. Thus, in this step, the depth information generation unit 331 subjects the image signals S1 and S2 to light quantity correction by using, for example, a light quantity correction value stored in a memory in advance.

In step S3332, the depth information generation unit 331 performs processing for reducing noise occurred in the photoelectric conversion by the image sensor 31. More specifically, the depth information generation unit 331 subjects the image signals S1 and S2 to filtering processing to implement noise reduction. Generally, the high-frequency region with higher spatial frequencies has a lower signal-to-noise (SN) ratio and hence relatively more noise components. Thus, the depth information generation unit 331 performs processing for applying a low-pass filter that reduces a passage rate further as the spatial frequency is higher. In the light quantity correction processing in step S3331, a desirable result may not be obtained depending on a manufacturing error or the like of the imaging optical system 30. Thus, it is desirable that the depth information generation unit 331 apply a band-pass filter that cuts off a direct current (DC) component and reduces the passage rate of a high frequency component.

In step S3333, the depth information generation unit 331 calculates the parallax amount between these images based on the image signals S1 and S2. More specifically, the depth information generation unit 331 sets, in the image signal S1, a target point corresponding to representative pixel information and a checking region centering on the target point. For example, the checking region may be a rectangular region, such as a square region, formed of four sides with a predetermined length centering on the target point. Then, the depth information generation unit 331 sets, in the image signal S2, a reference point and a reference region centering on the reference point. The reference region has the same size and the same shape as those of the checking region. The depth information generation unit 331 calculates a degree of correlation between an image included in the checking region of the image signal S1 and an image included in the reference region of the image signal S2 while sequentially moving the reference point, and then identifies a reference point having the highest degree of correlation as a corresponding point corresponding to the target point in the image signal S2. The relative amount of positional deviation between the identified corresponding point and the target point is the parallax amount at the target point.

The depth information generation unit 331 calculates the parallax amount while sequentially changing the target point based on the representative pixel information in this way to calculate parallax amounts at a plurality of pixel positions determined by the representative pixel information. In the present exemplary embodiment, to obtain the depth information with the same resolution as that of the image for viewing for the sake of simplification, the number of pixel positions subjected to the parallax amount calculation (pixel group included in the representative pixel information) is set to be the same number as the number of images for viewing. As a method for calculating the degree of correlation, normalized cross-correlation (NCC), sum of squared differences (SSD), or sum of absolute differences (SAD) can be used.

The calculated parallax amount can be converted into the defocus amount, which is the distance from the image sensor 31 to a focal point of the imaging optical system 30, by using a predetermined conversion coefficient. The parallax amount can be converted into the defocus amount by using the following Formula (1):

ΔL=K*d Formula (1)

where K denotes the predetermined conversion coefficient, and ΔL denotes the defocus amount. The conversion coefficient K is set for each region based on information including an aperture value, an exit pupil distance, and an image height in the image sensor 31.

The depth information generation unit 331 forms two-dimensional information including the thus-calculated defocus amount as a pixel value, and stores the information in a memory as a depth image.

In step S334, the layer division image generation unit 332 subjects the information about the image for viewing acquired in step S332 to the layer division based on the depth information acquired in step S333 to generate the layer division image data. The layer division image generation processing performed by the layer division image generation unit 332 is similar to the layer division image generation processing performed by the layer division image generation unit 12 according to the first exemplary embodiment, and thus redundant descriptions thereof will be omitted. The layer division image data may also be generated by using the method described in the second exemplary embodiment and the modification.

The present exemplary embodiment has been described on the premise that the image sensor 31 including the photoelectric conversion element by the imaging plane phase-difference distance measurement method acquires the image for viewing and the depth image. However, the acquisition of the distance information is not limited thereto in the embodiment of the disclosure. The distance information may be acquired by a stereo distance measurement method based on a plurality of captured images obtained, for example, by a binocular imaging apparatus or a plurality of different imaging apparatuses. Alternatively, the distance information may be acquired, for example, by a stereo distance measurement method using a light irradiation unit and an imaging apparatus, or a method that combines the time of flight (TOF) method and an imaging apparatus.

The first exemplary embodiment has been described centering on a form in which the image processing apparatus 100 receives the image information and the depth information corresponding to the image information from the outside, and generates the layer division image data based on the input image information and depth information. A fourth exemplary embodiment will be described centering on a form in which the depth information is generated by the image processing apparatus 100.

### Configuration of Image Processing Apparatus 100

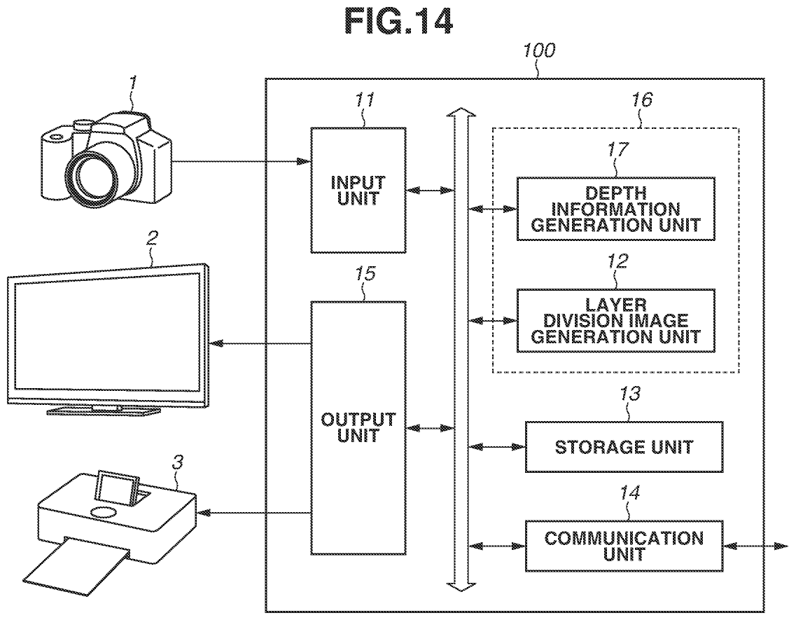

FIG. 14 is a block diagram illustrating an example of a functional configuration of an image processing apparatus 100 according to the fourth exemplary embodiment. The image processing apparatus 100 according to the present exemplary embodiment differs from the image processing apparatus 100 according to the first exemplary embodiment in that an image processing unit 16 includes a depth information generation unit 17. Other components are identical to those of the image processing apparatus 100 according to the first exemplary embodiment, and thus redundant descriptions thereof will be omitted.

The input unit 11 according to the present exemplary embodiment receives input of information necessary to generate the depth information instead of the depth information. The input information is transmitted to the depth information generation unit 17 in the image processing unit 16. The present exemplary embodiment will be described below centering on an example case where the depth information generation unit 17 receives input of the image signal S1 formed of the signal output only from the first photoelectric conversion portion 315, and the image signal S2 formed of the signal output only from the second photoelectric conversion portion 316.

### Depth Information Generation Processing

The depth information generation unit 17 generates the depth information based on the image signals S1 and S2. As with the depth information generation unit 331 included in the imaging apparatus 300 according to the third exemplary embodiment, the depth information generation unit 17 generates the depth information by performing the processing illustrated in the flowchart in FIG. 13B. The method for generating the depth information has been described in detail in the third exemplary embodiment, and thus redundant descriptions thereof will be omitted.

The disclosure can also be realized through processing in which a program for implementing at least one of the functions according to the above-described exemplary embodiments is supplied to a system or an apparatus via a network or a storage medium, and at least one processor in a computer of the system or the apparatus reads and executes the program. Further, the disclosure can also be realized by a circuit (for example, an application specific integrated circuit (ASIC)) that implements at least one of the functions.

The disclosure is not limited to the above-described exemplary embodiments but can be modified and changed in diverse ways without departing from the spirit and scope of the disclosure. Therefore, the following claims are appended to disclose the scope of the disclosure.

The disclosure makes it possible to provide an image processing apparatus capable of generating layer division image data necessary to form a molding that expresses a stereoscopic effect by printing images on each of a plurality of layers based on image data, and to provide a method for controlling the image processing apparatus, and a storage medium storing a program.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. An image processing apparatus comprising:
at least one processor; and
a memory coupled to the at least processor storing instructions that when execute by the processor, cause the processor to function as:
an acquisition unit configured to acquire image data and depth information corresponding to the image data;
an image processing unit configured to generate layer division image data based on the depth information by dividing the image data into a plurality of layers depending on a subject distance; and
an output unit configured to output the layer division image data,
wherein the layer division image data includes image data of a first layer including image data corresponding to a subject at a subject distance less than a first distance, and image data of a second layer including image data corresponding to a subject at a subject distance larger than or equal to the first distance, and
wherein the first distance changes based on the depth information.

2. The image processing apparatus according to claim 1, wherein the image data of the second layer includes at least part of the image data of the first layer.

3. The image processing apparatus according to claim 2, wherein the image data of the second layer includes the image data corresponding to the subject at the subject distance less than the first distance, and the image data corresponding to the subject at the subject distance exceeding the first distance.

4. The image processing apparatus according to claim 2,
wherein the image data of the first layer includes the image data corresponding to the subject at the subject distance less than the first distance, and
wherein the image data of the second layer includes the image data corresponding to the subject at the subject distance larger than or equal to a second distance and less than the first distance, the second distance being smaller than the first distance, and the image data corresponding to the subject at the subject distance larger than or equal to the first distance.

5. The image processing apparatus according to claim 1, wherein the image processing apparatus determines the first distance based on a histogram of the depth information.

6. The image processing apparatus according to claim 1, wherein the image processing unit extracts the image data corresponding to the subject at the subject distances less than the first distance from image data to generate the image data of the first layer.

7. The image processing apparatus according to claim 1, wherein the image processing apparatus generates the image data of the first layer and the image data of the second layer by dividing the image so that the distance included in the first layer and the distance included in the second layer are overlapped in a histogram of the depth information.

8. The image processing apparatus according to claim 1,
wherein the processor or circuit further functions as a depth information generation unit configured to acquire the depth information, and
wherein the acquisition unit acquires the depth information from the depth information generation unit.

9. The image processing apparatus according to claim 1, wherein the depth information includes at least any one of distance information, defocus information, or parallax information.

10. An image processing method comprising:
acquiring image data and depth information corresponding to the image data;
generating layer division image data based on the depth information by dividing the image data into a plurality of layers depending on a subject distance; and
outputting the layer division image data,
wherein the layer division image data includes image data of a first layer including image data corresponding to a subject at a subject distance less than a first distance, and image data of a second layer including image data corresponding to a subject at a subject distance larger than or equal to the first distance, and
wherein the first distance changes based on the depth information.

11. The image processing method according to claim 10, wherein the image data of the second layer includes at least part of the image data of the first layer.

12. The image processing method according to claim 10, further comprising:
determining the first distance based on a histogram of the depth information.

13. The image processing method according to claim 10, further comprising:
extracting the image data corresponding to the subject at the subject distances less than the first distance from image data to generate the image data of the first layer.

14. The image processing method according to claim 10, further comprising:
generating the image data of the first layer and the image data of the second layer by dividing the image so that the distance included in the first layer and the distance included in the second layer are overlapped in a histogram of the depth information.

15. A non-transitory computer-readable storage medium storing a program for causing a computer to perform an image processing method, the method comprising:
acquiring image data and depth information corresponding to the image data;
generating layer division image data based on the depth information by dividing the image data into a plurality of layers depending on a subject distance; and
outputting the layer division image data,
wherein the layer division image data includes image data of a first layer including image data corresponding to a subject at a subject distance less than a first distance, and image data of a second layer including image data corresponding to a subject at a subject distance larger than or equal to the first distance, and
wherein the first distance changes based on the depth information.

16. The non-transitory computer-readable storage medium according to claim 15, wherein the image data of the second layer includes at least part of the image data of the first layer.

17. The non-transitory computer-readable storage medium according to claim 15, further comprising:
determining the first distance based on a histogram of the depth information.

18. The non-transitory computer-readable storage medium according to claim 15, further comprising:
extracting the image data corresponding to the subject at the subject distances less than the first distance from image data to generate the image data of the first layer.

19. The non-transitory computer-readable storage medium according to claim 15, further comprising:
generating the image data of the first layer and the image data of the second layer by dividing the image so that the distance included in the first layer and the distance included in the second layer are overlapped in a histogram of the depth information.
